(19) United States
(12) Patent Application Publication
(10) Pub. No.: US 2024/0175631 A1
(43) Pub. Date: May 30, 2024

(54) METHOD AND SYSTEM FOR DRYING AN ACTIVE PART OF A TRANSFORMER

(71) Applicant: PROLEC-GE INTERNACIONAL, S. DE R. L. DE C. V., Apodaca (MX)

(72) Inventor: Gerardo TAMEZ TORRES, Guadalupe (MX)

(21) Appl. No.: 18/518,554

(22) Filed: Nov. 23, 2023

(30) Foreign Application Priority Data
Nov. 25, 2022 (MX) MX A/2022/014926

(51) Int. Cl. F26B 25/22; F26B 5/04; F26B 21/10

(52) U.S. Cl. CPC F26B 25/22; F26B 5/042; F26B 21/10; H01F 41/00

(57) ABSTRACT

A method and system for drying an active part of an electric transformer, by continuously determining a moisture content in the solid insulations during vapor phase drying in a drying oven and stopping this drying when an equilibrium moisture content is reached. Then, continuously determining a moisture content in the solid insulations during the retightening and geometric adjustment phase of the active part outside the drying oven and continuing with the determination of moisture content during vacuum drying once the active part is inside the hermetically sealed tank, and stopping vacuum drying when an equilibrium moisture content is reached in the solid insulations. The determination of moisture content and equilibrium moisture content is carried out by applying the diffusion equation.

### TECHNICAL FIELD OF THE INVENTION

The present invention relates to electric power or distribution transformers, and more particularly to a method and system for drying an active part of an electric transformer during its assembly.

### BACKGROUND OF THE INVENTION

An electric power or distribution transformer consists of an active part corresponding to the electrical and magnetic circuits, and a passive part that houses the active part.

The active part generally comprises the magnetic circuit, which consists of a magnetic core typically made of laminated steel, forming a structure of columns and yokes; the electrical circuit, which includes at least one winding wound on each column of the magnetic core, made of copper or aluminum wire insulated with solid insulating material, typically cellulose-based paper; a tap changer that regulates the electrical voltage flowing through the transformer; and a frame composed of structural elements that support the magnetic core and windings and function to withstand the mechanical and electromechanical forces that occur during transformer operation.

The passive part consists of a tank filled with dielectric oil, where the active part is housed. The tank is hermetic to withstand vacuum without permanent deformation, provides mechanical and electrical protection for the active part, and supports high-voltage and low-voltage bushings, coolers, oil pumps, fans, and special accessories.

During the manufacturing of power or distribution transformers, the active and passive parts are assembled separately to later insert the active part into the passive part. During the assembly of the active part, the solid cellulose-based insulation of the windings absorbs a certain amount of moisture depending on the surrounding ambient humidity. Typically, the solid insulation, being hygroscopic, will absorb moisture of approximately 5 to 10% of its own weight when exposed to the open air.

However, under operational conditions of the electric transformer, the moisture content of the solid insulation must be as low as approximately 0.5% to ensure the required insulation properties. Therefore, in the manufacturing of power or distribution transformers, once the active part is assembled, it undergoes a series of phases where the solid insulation loses and gains moisture. These phases include: introducing the active part into a drying oven for vapor phase drying, removing the active part from the drying oven for retightening and geometric adjustment, placing the active part inside the transformer tank and sealing it hermetically, subjecting the active part to vacuum drying inside the tank before filling it with dielectric oil, preparing the electric transformer for shipment, and vacuum drying the active part again before shipping. This drying process is described in the following publications: Krause Ch., Gasser H. P., Kiriyanthan K.: The Remaining Water in Power Transformer Insulation After Drying. 16th International Symposium on High Voltage Engineering, Johannesburg 2009; and Krause C., Goetz W., Heinrich B., The impact of drying and oil impregnation conditions and of temperature cycles on the clamping force of power transformer windings, Conference Record of the 2002 IEEE International Symposium on Electrical Insulation.

Vapor phase drying is the preferred technology for removing moisture from the solid insulation in the factory; kerosene vapor is used to add heat to the active part, followed by vacuum drying once a required temperature is reached (see Bangar A., Sharma R., Tripathi H., Bhanpurkar A. Comparative Analysis of Moisture Removing Processes from Transformer which are Used to Increase its Efficiency. Global Journal of Researches in Engineering, Mechanical and Mechanics Engineering, Volume 12, Issue 5, Version 1.0. 2012; and Sawant C., Nalawade M., Choudhary N. Experimental Investigation of Vapour Phase Drying System. International Engineering Research Journal. Special Edition. 2017). This process can achieve moisture levels as low as 0.2% by weight.

While the active part is drying, the winding clamping system loosens, requiring it to be retightened and its geometry adjusted before placing the active part inside the tank. Retightening is carried out while the active part is exposed to the atmosphere, during which it may reabsorb some moisture from the air (see Krause C., Goetz W. The Change of the Clamping Pressure in Transformer Windings due to Variation of the Moisture Content-Tests with pressboard spacer stacks. CIGRE SC 12 Transformers/Workshop on Short Circuit Performance of Transformers, 1999 Budapest Colloquium. 1999; and Prevost, T., Woodcock, D., Krause, C. The effects on winding clamping pressure due to changes in moisture, temperature, and insulation age. DOBLE, Sixty-Seventh Annual International Conference of Doble Clients, Boston, Massachusetts U.S.A., 2000). This adsorbed moisture must be removed through vacuum drying once the active part is inside the tank and before filling it with dielectric oil.

Once the electric transformer has been assembled, it undergoes laboratory dielectric tests. Once these tests are successfully completed, the electric transformer can be disassembled again to prepare it for shipping. Consequently, the active part, already impregnated with dielectric oil, is exposed once more to the environment, leading to moisture absorption. Therefore, it is necessary to perform vacuum drying again on the active part once the electric transformer is reassembled at the customer's delivery site (see Krause C., Gasser H. The Effect of Oiling the Insulation of Power Transformers on the Efficiency of the Final Vacuum Cycle. 2006 IEEE International Symposium on Electrical Insulation (ISEI), Delta Chelsea Hotel Toronto, ON, Canada. 2006; and Krause C. Water Adsorption of Transformer Insulation Exposed to Air. CIGRE, SC 15, Preferential Subject No 2, Interfacial Phenomena, Question No 9, Paris 2000).

The evaluation and control of moisture content in the solid insulation throughout each of the aforementioned phases is a significant challenge. Generally, empirical drying “recipes” are employed based on the transformer's design, transformation voltage level, and the weight of the solid insulation used. These “recipes” specify fixed temperatures, pressures, and times to which the active part of the transformer should be subjected in the drying oven and in subsequent vacuum drying phases, resulting in a drying process that can take up to several days, causing production line bottlenecks.

The drying process based on these empirical “recipes” involves collecting the released water (extracted by vacuum) and based on an average of the absorbed moisture or when a certain level of moisture extraction is reached, it determines the sufficiency of the drying and consequently the time the active part should remain in the drying oven and in subsequent vacuum drying phases. This open-loop control strategy has some disadvantages and can lead to unnecessary exposure of solid insulations to high temperatures when they may already be dry or, conversely, end the drying process prematurely, causing the solid insulations of the active part to still have a moisture content above the allowable moisture content for proper transformer operation, which could result in a failure.

Therefore, to address the aforementioned issue, it is necessary to provide a method and system for drying an active part of an electric transformer that considers the evolution of the physical phenomena of moisture adsorption and desorption in solid insulation. This method should allow for real-time, continuous, and direct measurement of moisture content throughout the entire drying process.

### SUMMARY OF THE INVENTION

In view of the aforementioned description and with the purpose of addressing the identified limitations, the invention aims to provide a method for drying an active part of an electric transformer, the active part includes at least one winding and solid cellulose-based insulation, the method comprises the following steps: (a) subjecting the active part to vapor phase drying in a drying oven starting from a preset temperature and pressure, continuously determining a moisture content in the solid insulation in function of temperature and pressure being sensed within the drying oven, and the vapor phase drying continues until the moisture content of the solid insulation reaches an equilibrium moisture content in function of a moisture desorption from the solid insulation; (b) allowing ambient moisture adsorption in the solid insulation by removing the active part from the drying oven for retightening and geometric adjustment, continuously determining a moisture content in the solid insulation in function of the temperature of the active part, ambient temperature, and relative humidity sensed outside the drying oven; (c) placing the active part inside a transformer tank, sealing the tank hermetically; and (d) applying vacuum pressure inside the tank, allowing vacuum drying of the active part, continuously determining moisture content in the solid insulation in function of the temperature of the active part and the vacuum pressure being sensed inside the tank, and the application of vacuum pressure inside the hermetic tank continues until the moisture content of the solid insulation reaches an equilibrium moisture content in function of a moisture desorption from the solid insulation.

The present invention also aims to provide a system for drying an active part of an electric transformer, the active part includes at least one winding and solid cellulose-based insulation, the system is formed by: at least one first temperature sensor for continuously sensing temperature inside a drying oven, the drying oven enabled to carry out a vapor phase drying; at least one first pressure sensor for continuously sensing pressure inside the drying oven; at least one second temperature sensor for continuously sensing ambient temperature outside the drying oven; at least one relative humidity sensor for continuously sensing relative humidity outside the drying oven; at least one third temperature sensor for continuously sensing temperature in the active part once it is removed from the drying oven; at least one second pressure sensor for continuously sensing pressure inside a hermetically sealed transformer tank containing the active part being dried; a control unit in communication with the first temperature sensor, the first pressure sensor, the second temperature sensor, the relative humidity sensor, the third temperature sensor, and the second pressure sensor, the control unit includes: at least one programmable memory for presetting a start temperature and pressure for drying; and an electronic processor enabled to: (a) continuously determining a moisture content in the solid insulation in function of temperature and pressure sensed inside the drying oven by the first temperature sensor and the first pressure sensor, respectively; (b) determining the moment when the moisture content of the solid insulation inside the drying oven reaches an equilibrium moisture content in function of a moisture desorption from the solid insulation; (c) continuously determining a moisture content in the solid insulation outside the drying oven in function of temperature of the active part, ambient temperature, and relative humidity sensed outside the drying oven by the third temperature sensor, second temperature sensor, and relative humidity sensor, respectively; (d) continuously determining a moisture content in the solid insulation in function of the temperature of the active part and vacuum pressure sensed inside the transformer tank by the third temperature sensor and second pressure sensor, respectively, once vacuum pressure has been applied to the tank to continue drying the active part; and (e) determining the moment when the moisture content of the solid insulation inside the tank reaches an equilibrium moisture content in function of a moisture desorption from the solid insulation.

### BRIEF DESCRIPTION OF THE FIGURES

The characteristic details of the invention are described in the following paragraphs together with the accompanying figures. These are intended to define the invention but not to limit its scope.

FIG. 1 illustrates a system for drying an active part of an electric transformer in accordance with the present invention;

FIG. 2 illustrates a block diagram of a first embodiment of a control unit in accordance with the present invention;

FIG. 3 illustrates a block diagram of a second embodiment of a control unit in accordance with the present invention;

FIGS. 4A and 4B illustrate a flowchart of a method for drying an active part of an electric transformer in accordance with the present invention;

FIG. 5 illustrates a progress chart of pressure, temperature, and moisture content parameters over time in an exemplary embodiment of the present invention during a vapor phase drying phase of an active part;

FIG. 6 illustrates a progress chart of pressure, temperature, and moisture content parameters over time in an exemplary embodiment of the present invention during a retightening and geometric adjustment phase of an active part; and

FIG. 7 illustrates a progress chart of pressure, temperature, and moisture content parameters over time in an exemplary embodiment of the present invention during a vacuum drying phase of an active part.

### DETAILED DESCRIPTION OF THE INVENTION

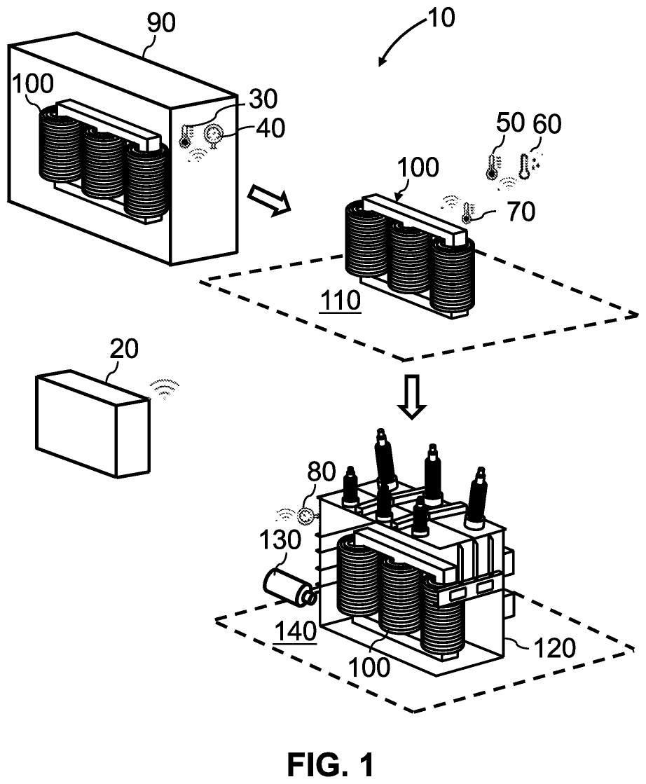

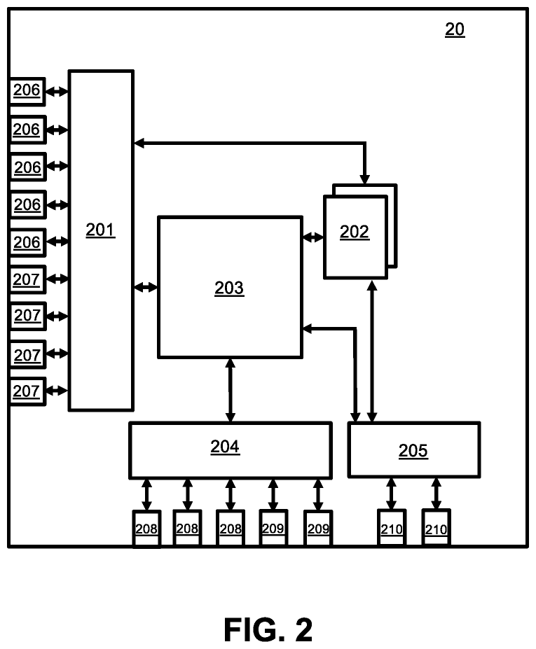

Referring to FIGS. 1 and 2, illustrating a system for drying an active part of an electric transformer and a block diagram of a first embodiment of a control unit according to the present invention, respectively. System 10 comprises a control unit 20 in wired or wireless communication with at least a first temperature sensor 30, at least a first pressure sensor 40, at least a second temperature sensor 50, at least a relative humidity sensor 60, at least a third temperature sensor 70, and at least a second pressure sensor 80.

The first temperature sensor 30 is enabled to continuously sense the temperature inside a drying oven 90, within which an active part 100 is being dried through a vapor phase drying process. The first temperature sensor 30 is enabled to communicate information about this temperature to the control unit 20.

The first pressure sensor 40 is enabled to continuously sense pressure inside the drying oven 90 during the vapor phase drying process applied to the active part 100. The first pressure sensor 40 is enabled to communicate information about this pressure to the control unit 20.

The second temperature sensor 50 is enabled to continuously sense an ambient temperature outside the drying oven 90, particularly the ambient temperature of a first working zone 110, where retightening and geometric adjustment activities on the active part 100 are carried out once the active part 100 exits the drying oven 90. The second temperature sensor 50 is enabled to communicate information about this ambient temperature to the control unit 20.

The relative humidity sensor 60 is enabled to continuously sense a relative humidity outside the drying oven 90, particularly the relative humidity of the first working zone 110. The relative humidity sensor 60 is enabled to communicate information about this relative humidity to the control unit 20.

The third temperature sensor 70 is enabled to continuously sense a temperature of the active part 100 when it is in the first working zone 110. The third temperature sensor 70 is enabled to communicate information about this temperature of the active part 100 to the control unit 20.

The second pressure sensor 80 is enabled to continuously sense a pressure inside a transformer tank 120 once the active part 100 is placed inside the tank 120 and it is hermetically sealed. This is done to proceed with vacuum drying by connecting the tank 120 to a vacuum pump 130 in a second working zone 140. The second pressure sensor 80 is enabled to communicate information about this pressure inside the transformer tank 120 to the control unit 20.

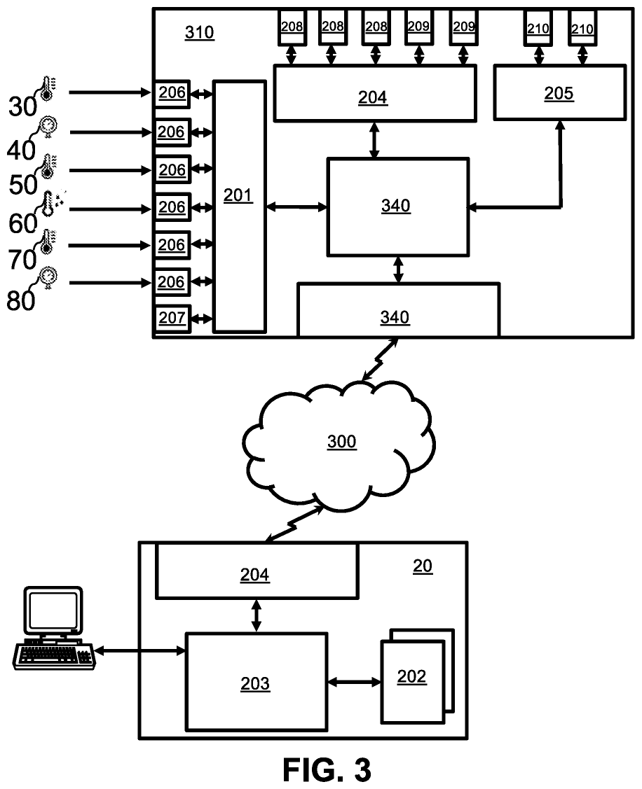

The control unit 20 can be located in situ, where the drying process of the active part 100 is carried out, or remotely operating as a remote control center, as shown later in FIG. 3.

The control unit 20 includes a first communication interface 201, at least one programmable memory 202, and an electronic processor 203. Additionally, it comprises a second communication interface 204 and a user interface module 205.

The first communication interface 201 allows communication with the first temperature sensor 30, the first pressure sensor 40, the second temperature sensor 50, the relative humidity sensor 60, the third temperature sensor 70, and the second pressure sensor 80 under a first communication protocol. The first communication interface 201 has a plurality of wired communication ports 206 selected from the group consisting of RS-232, RS-485, RJ45, UART, and combinations thereof, such that each of these wired communication ports is connected by cable to each of said first temperature sensor 30, first pressure sensor 40, second temperature sensor 50, relative humidity sensor 60, third temperature sensor 70, and second pressure sensor 80. The first communication interface 201 may also include a plurality of wireless receivers 207 selected from the group consisting of Bluetooth, Wi-Fi, and combinations thereof, where each of these wireless receivers is connected by signal to each of said first temperature sensor 30, first pressure sensor 40, second temperature sensor 50, relative humidity sensor 60, third temperature sensor 70, and second pressure sensor 80.

Alternatively, the second communication interface 204 allows communication with a control module (not shown) of the drying oven 90 and with a control module (not shown) of the vacuum pump 130 to communicate operating instructions. The second communication interface 204 has a plurality of wired communication ports 208 selected from the group consisting of RS-232, RS-485, RJ45, UART, and combinations thereof, such that each of these wired communication ports is connected by cable to each of said control modules of the drying oven 90 and the vacuum pump 130. The second communication interface 204 may also include a plurality of wireless receivers 209 selected from the group consisting of Bluetooth, WIFI, and combinations thereof, where each of these wireless receivers is connected by signal to each of said control modules of the drying oven 90 and the vacuum pump 130.

In the programmable memory 202, information is stored and pre-set, including a temperature and pressure for the operation of the drying oven 90; identification information for each of said first temperature sensor 30, first pressure sensor 40, second temperature sensor 50, relative humidity sensor 60, third temperature sensor 70, and second pressure sensor 80; and alternatively, operational information from each of said control modules of the drying oven 90 and the vacuum pump 130, as well as information from each of said first temperature sensor 30, first pressure sensor 40, second temperature sensor 50, relative humidity sensor 60, third temperature sensor 70, and second pressure sensor 80. The programmable memory 202 can be, for example, a Random Access Memory (RAM), Read-Only Memory (ROM), Static RAM (SRAM), Virtual or SWAP memory, Electrically Erasable Programmable Read-Only Memory (EEPROM), or any combination thereof.

The information stored in the programmable memory 202 for each of said first temperature sensor 30, first pressure sensor 40, second temperature sensor 50, relative humidity sensor 60, third temperature sensor 70, and second pressure sensor 80, and alternatively operational information from each of said control modules of the drying oven 90 and the vacuum pump 130 may include at least a sensor identifier, a wired communication port 206 or 208 number to which it is connected, operational communication protocol, among other types of information.

The information stored in the programmable memory 202 can be programmed or pre-set locally through the user interface module 205. The user interface module 205 may be mounted on the control unit 20 or be separate from the control unit 20 but in connection and communication with the electronic processor 203. Typically, through the user interface module 205, a user can select various operational features and modes, and monitor the operation of the control unit 20. In certain exemplary embodiments, the user interface module 205 may allow wired or wireless connection of a General-Purpose Input/Output (“GPIO”) or functional block through one of its communication ports 210. The user interface module 205 may also include input components, such as one or more of a variety of input devices, mechanical or electromechanical or electrical, including USB ports, rotary controls, buttons, and touchpads. The user interface panel may further include a display component, such as a digital or analog display device designed to provide operational information from the control unit 20 to a user.

The electronic processor 203 is connected to the first communication interface 201, the second communication interface 204, the programmable memory 202, and the user interface module 205. The electronic processor 203 is enabled to: (a) continuously determining a moisture content in the solid insulation of the active part 100 in function of a temperature and pressure sensed inside the drying oven 90 by the first temperature sensor 30 and the first pressure sensor 40, respectively; (b) determining the moment when the moisture content of the solid insulation of the active part 100 inside the drying oven 90 reaches an equilibrium moisture content in function of a moisture desorption from the solid insulation; (c) continuously determining a moisture content in the solid insulation of the active part 100 outside the drying oven 90 in function of temperature of the active part 100, ambient temperature, and relative humidity sensed outside the drying oven by the third temperature sensor 70, the second temperature sensor 50, and the relative humidity sensor 60, respectively; (d) continuously determining a moisture content in the solid insulation of the active part 100 in function of the temperature of the active part 100 and the vacuum pressure sensed inside the transformer tank 120 by the third temperature sensor 70 and the second pressure sensor 80, respectively, once vacuum pressure has been applied to the tank 120 to continue drying the active part 100; and (e) determining the moment when the moisture content of the solid insulation of the active part 100 inside the tank 120 reaches an equilibrium moisture content in function of a moisture desorption from the solid insulation.

In an alternative embodiment, the electronic processor 203 is further enabled to instruct the control module (not shown) of the drying oven 90 to stop the vapor phase drying when the electronic processor 203 has determined the moment when the moisture content of the solid insulation inside the drying oven 90 has reached an equilibrium moisture content in function of a moisture desorption from the solid insulation.

In another alternative embodiment, the electronic processor 203 is enabled to instruct the control module (not shown) of the vacuum pump 203 to stop applying vacuum pressure when the electronic processor 203 has determined the moment when the moisture content of the solid insulation inside the tank 120 has reached an equilibrium moisture content in function of a moisture desorption from the solid insulation.

The electronic processor 203 can include a microprocessor, a microcontroller, a digital signal processor, an analog signal processing circuit, an application-specific integrated circuit (ASIC), a field-programmable gate array (FPGA) device, a system-on-chip (SoC), a complex programmable logic device (CPLD), digital logic, combinational logic, sequential logic, any other computing device, logical device, state machine, or any combination thereof. The electronic processor 203 may involve software, firmware, hardware, or any combination thereof.

In FIG. 3, a block diagram of a second embodiment of a control unit according to the present invention is illustrated. In this embodiment, the control unit 20 is located remotely from the place where the drying process of the active part 100 is carried out, operating as a remote control center through an Internet network 300. The first temperature sensor 30, the first pressure sensor 40, the second temperature sensor 50, the relative humidity sensor 60, the third temperature sensor 70, the second pressure sensor 80, the control module (not shown) of the drying oven 90, and the control module (not shown) of the vacuum pump 203 act as interconnected devices operating under the Internet of Things (IoT) scheme, where all of them can be visible and interact with the control unit 20 through the Internet network 300.

In this embodiment, the control unit 20 can communicate with a measurement hub 310 through the Internet network 300 using PLC networks, fiber optics, GPRS, EDGE, 3G, 4G, and radiofrequency (900 MHz or 2.4 GHZ), or low-power wide-area network (LP-WAN) technologies. Meanwhile, the measurement hub 310 communicates with the first temperature sensor 30, the first pressure sensor 40, the second temperature sensor 50, the relative humidity sensor 60, the third temperature sensor 70, the second pressure sensor 80, the control module (not shown) of the drying oven 90, and the control module (not shown) of the vacuum pump 203 through wired technology such as RS-232, RS-485, RJ45, UART, and their combinations, or wireless technology such as Bluetooth, Wi-Fi, and combinations thereof.

For this embodiment, the control unit 20 consists of the programmable memory 202, the electronic processor 203, and a communication interface 320 to maintain communication with the measurement hub 310. The measurement hub 310 consists of the first communication interface 201 with the plurality of wired communication ports 206 and the plurality of wireless receivers 207, the second communication interface 204 with the plurality of wired communication ports 208 and the plurality of wireless receivers 209, the user interface module 205 with communication ports 210, a communication interface 330 to maintain communication with the control unit 20, and a microcontroller 340 in connection with the first communication interface 201, the second communication interface 204, the user interface module 205, and the communication interface 330. The microcontroller 340 controls the measurement hub 310.

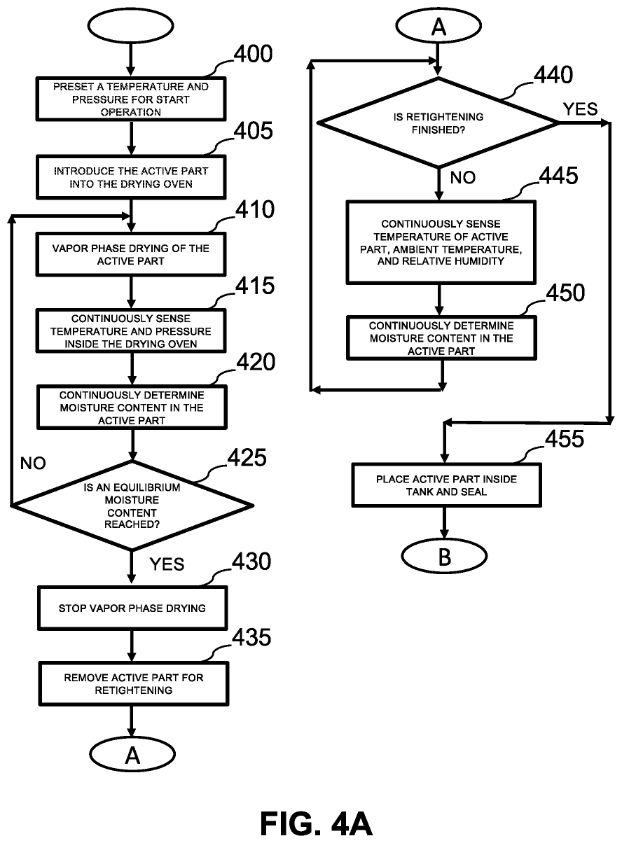

Now, in FIGS. 4A and 4B, a flowchart illustrates a method for drying an active part of an electric transformer in accordance with the present invention. The method begins at step 400, where a temperature and pressure for the start of the vapor phase drying operation for the drying oven 90 are preset in the programmable memory 202. The preset temperature and pressure are in function of design data for the active part 100. Then, at step 405, the active part 100 is introduced into the drying oven 90, and a vapor phase drying operation is initiated at step 410 based on the preset temperature and pressure. At step 415, temperature and pressure are continuously sensed within the drying oven 90, using the first temperature sensor 30 and the first pressure sensor 40 to continuously determine, at step 420, a moisture content in the active part 100. This determination is carried out in the electronic processor 203. Vapor phase drying continues until the electronic processor 203 determines that the moisture content has reached its equilibrium, at step 425. Once equilibrium in the moisture content is achieved, the vapor phase drying is stopped at step 430, and then, at step 440, the active part 100 is removed from the drying oven 90 to be subjected to retightening and geometric adjustment in the same step.

During the phase of retightening and geometric adjustment of the active part 100, the temperature of the active part, the ambient temperature, and the relative humidity of the working area where the retightening is carried out are continuously sensed at step 445. The temperature of the active part is sensed by the third temperature sensor 70, the ambient temperature is sensed by the second temperature sensor 50, and the relative humidity is sensed by the relative humidity sensor 60, communicating this information to the control unit 20. This data is used to continuously determine, at step 450, a moisture content in the active part 100. This determination is carried out in the electronic processor 203. Once the phase of retightening and geometric adjustment of the active part 100 is completed at step 440, then, at step 455, the active part 100 is placed inside the tank 120, and it is hermetically sealed.

The tank 120 with the active part 100 is connected to the vacuum pump 130 to proceed, at step 460, with a vacuum drying; at step 465, temperature and pressure inside the tank 120 are continuously sensed using the third temperature sensor 70 and the second pressure sensor 80 to continuously determine, at step 470, a moisture content in the active part 100. This determination is carried out in the electronic processor 203. Vacuum drying continues until the electronic processor 203 determines that the moisture content has reached its equilibrium, at step 475. Once equilibrium in the moisture content is achieved, the vacuum drying is stopped ate step 480, and a transformer testing phase is initiated at step 485.

The continuous determination of the moisture content and the equilibrium moisture content in the active part 100 is carried out as follows:

Solid cellulose-based insulations are hydrophilic: they can absorb moisture up to 10% of their own weight. The moisture extraction in solid insulations can be mathematically described by the diffusion equation. In the one-dimensional case, the diffusion equation takes the following form:

$$\frac{\partial C}{\partial t} = \frac{\partial }{\partial x} ( D \frac{\partial C}{\partial x} ) \qquad ( 1 )$$

where C is the moisture content in the solid insulation expressed as a weight fraction of the dry insulation, D is the moisture diffusion coefficient (m²/s), x is the spatial coordinate (m), and t is the time (s). It has been found in the prior art that the value of the moisture diffusion coefficient is a function of temperature and moisture content, and it can be represented by the following model:

$$D ( {T}_{k} , C ) = {D}_{G} \cdot \text{?} \qquad ( 2 )$$

$$\text{?} \text{indicates text missing or illegible when filed}$$

where Tₖ is the temperature in Kelvin, T₀ is the normal ambient temperature (298.15 K), and C is the moisture content. The parameters D_{G}, k, and Eₐ take different values depending on whether the material is pressboard or Kraft paper, and whether they are impregnated with mineral oil or unimpregnated.

In the vapor phase drying process, the active part is placed in a drying oven where a temperature between 115 and 120 ° C. is maintained, and the pressure is reduced to less than 0.25 mmHg. This results in the desorption of moisture, which can be described by the following boundary condition:

$$- D \frac{\partial C}{\partial x} = α ( {C}_{e} - {C}_{s} ) \qquad ( 3 )$$

where α is the mass transfer coefficient (m/s), Cₑ is the moisture concentration I thermodynamic equilibrium moisture for a given pressure and temperature, and Cₛ is the moisture concentration on the surface of the insulation at a given time. Based on the state of the art, it has been found that within the drying oven:

$${C}_{e} = 2.173 \times {10}^{- 7} \cdot \text{?} \cdot {e}^{( \frac{4725.6}{{T}_{k}} )} \qquad ( 4 )$$

$$\text{?} \text{indicates text missing or illegible when filed}$$

where P is the pressure in mmHg and Tₖ is the temperature in Kelvin.

During the retightening process, the active part is exposed to the environment, and air humidity re-enters the solid insulation by adsorption. Since cellulose is hygroscopic, its surface quickly reaches equilibrium, which can be described by the following boundary condition:

Cₛ=C_{∞} (5)

where C_{∞} is a function of air temperature and relative humidity, as shown below:

$${C}_{∞} = \frac{1800}{nW} [ \frac{KH}{1 - KH} + \frac{{K}_{1} KH + 2 {K}_{1} {K}_{2} {K}^{2} {H}^{2}}{1 + {K}_{1} KH + {K}_{1} {K}_{2} {K}^{2} {H}^{2}} ] \qquad ( 6 )$$

where H is the relative humidity fraction of the air (%/100), n is a dimensionless factor with an approximate value of 2 that allows adjusting the maximum moisture concentration that the insulations can contain,

W=349+1.29·T_{∞}+0.0135·T_{∞}²

K=0.805+0.000736·T_{∞}−0.00000273·T_{∞}²

K₁=6.27−0.00938·T_{∞}−0.000303·T_{∞}²

K₂=1.91+0.0407·T_{∞}−0.000293·T_{∞}²

and T_{∞} is the ambient air temperature in Celsius. During the retightening process, the active part is hotter than the air, so a correction in the relative humidity of the air must be made before calculating the equilibrium moisture concentration of the solid insulation. Based on the ambient temperature, T_{∞}, and the relative humidity fraction of the air, H, the volumetric moisture density in the air VD is calculated as:

VD=H×(6.335+0.6718·T_{∞}−0.020887·T_{∞}²+0.00073095·T_{∞}³), g/m³ (7)

The relative humidity of the air Hₚᵥ moving through the ducts of the active part at the temperature of the active part, Tₚᵥ, is:

$${H}_{pv} = \frac{VD}{6.335 + 0.6718 \cdot {T}_{pv} - 0.020887 \cdot {T}_{pv}^{2} + 0.00073095 \cdot {T}_{pv}^{3}} \qquad ( 8 )$$

by replacing Hₚᵥ with H and Tₚᵥ with T_{∞} in equation (8), the equilibrium moisture content, C_{∞}, is obtained, which serves as a boundary condition (5).

The equations describing moisture desorption/adsorption are solved using numerical techniques in the electronic processor 203, with inputs being the information sensed by each of said first temperature sensor 30, first pressure sensor 40, second temperature sensor 50, relative humidity sensor 60, third temperature sensor 70, and second pressure sensor 80 throughout the drying process. The real-time output/result is the moisture content in the solid insulation.

### Example of the Invention Embodiment

The invention will now be described with respect to the following example, which is solely for the purpose of illustrating how to implement the principles of the invention. The following example is not intended to be an exhaustive representation of the invention, nor does it attempt to limit the scope thereof.

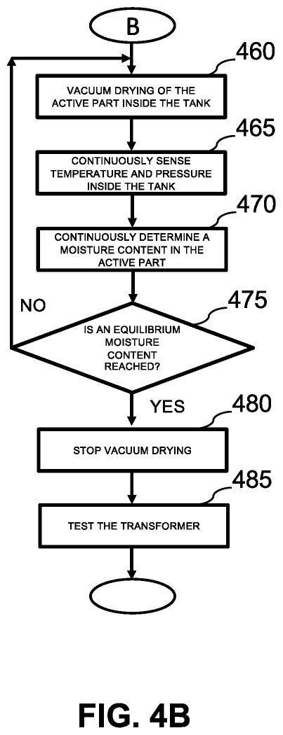

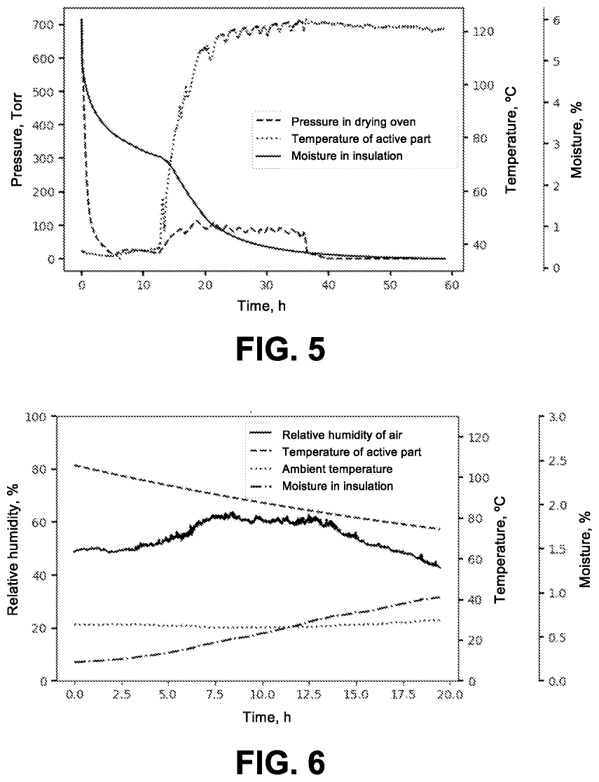

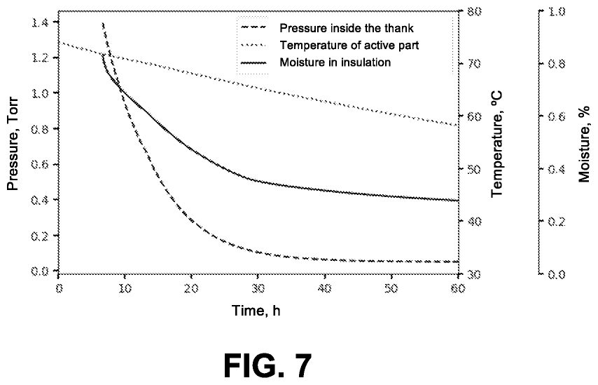

A three-phase transformer's active part, with 1,200 kg of solid insulation undergoes an initial temperature of 120° C. at an absolute pressure of 0.25 Torr in a drying oven, reaching equilibrium moisture content within a period of 59 hours, as shown in FIG. 5. Then, in the retightening process, the ambient temperature is 28° C. with an average relative humidity of 55%, and with an initial temperature of the active part at 104° C. and final temperature of 78° C. The retightening process lasted 19 hours, showing the following moisture content variation due to moisture adsorption, reaching 1.0% as shown in FIG. 6. Finally, the active part is places in the tank and sealed, with an initial temperature of the active part at 75° C. and maintaining a vacuum pressure of 0.1 Torr, reaching equilibrium moisture content whiting a period of 60 hours, as shown in FIG. 7.

Based on the embodiments described above, it is contemplated that modifications to the described embodiments, as well as alternative embodiments, will be apparent to one skilled in the art in view of the present disclosure. Therefore, it is contemplated that the claims encompass such modifications and alternatives that fall within the scope of the present invention or its equivalents.

1. A method for drying an active part of an electric transformer, the active part includes at least one winding and solid cellulose-based insulation, the method comprises the steps of:
subjecting the active part to vapor phase drying in a drying oven starting from a preset temperature and pressure, continuously determining a moisture content in the solid insulation in function of temperature and pressure being sensed within the drying oven, and the vapor phase drying continues until the moisture content of the solid insulation reaches an equilibrium moisture content in function of a moisture desorption from the solid insulation;
allowing ambient moisture adsorption in the solid insulation by removing the active part from the drying oven for retightening and geometric adjustment, continuously determining a moisture content in the solid insulation in function of the temperature of the active part, ambient temperature, and relative humidity sensed outside the drying oven;
placing the active part inside a transformer tank, sealing the tank hermetically; and
applying vacuum pressure inside the tank, allowing vacuum drying of the active part, continuously determining moisture content in the solid insulation in function of the temperature of the active part and the vacuum pressure being sensed inside the tank, and the application of vacuum pressure inside the hermetic tank continues until the moisture content of the solid insulation reaches an equilibrium moisture content in function of a moisture desorption from the solid insulation.

2. The method of claim 1, wherein in the step of subjecting the active part to vapor phase drying in a drying oven starting from a preset temperature and pressure, the preset temperature and pressure are in function of design data of the active part.

3. A system for drying an active part of an electric transformer, the active part includes at least one winding and solid cellulose-based insulation, the system comprising:
at least one first temperature sensor for continuously sensing temperature inside a drying oven, the drying oven enabled to carry out a vapor phase drying;
at least one first pressure sensor for continuously sensing pressure inside the drying oven;
at least one second temperature sensor for continuously sensing ambient temperature outside the drying oven;
at least one relative humidity sensor for continuously sensing relative humidity outside the drying oven;
at least one third temperature sensor for continuously sensing temperature in the active part once it is removed from the drying oven;
at least one second pressure sensor for continuously sensing pressure inside a hermetically sealed transformer tank containing the active part being dried;
a control unit in communication with the first temperature sensor, the first pressure sensor, the second temperature sensor, the relative humidity sensor, the third temperature sensor, and the second pressure sensor, the control unit includes:
at least one programmable memory for presetting a start temperature and pressure for drying; and
an electronic processor enabled to:
continuously determining a moisture content in the solid insulation in function of temperature and pressure sensed inside the drying oven by the first temperature sensor and the first pressure sensor, respectively;
determining the moment when the moisture content of the solid insulation inside the drying oven reaches an equilibrium moisture content in function of a moisture desorption from the solid insulation;
continuously determining a moisture content in the solid insulation outside the drying oven in function of temperature of the active part, ambient temperature, and relative humidity sensed outside the drying oven by the third temperature sensor, second temperature sensor, and relative humidity sensor, respectively;
continuously determining a moisture content in the solid insulation in function of the temperature of the active part and vacuum pressure sensed inside the transformer tank by the third temperature sensor and second pressure sensor, respectively, once vacuum pressure has been applied to the tank to continue drying the active part; and
determining the moment when the moisture content of the solid insulation inside the tank reaches an equilibrium moisture content in function of a moisture desorption from the solid insulation.

4. The system of claim 3, further wherein the control unit is in communication with a control module of the drying oven, and the electronic processor is enabled to instruct the drying oven control module to stop vapor phase drying when the electronic processor has determined the moment when the moisture content of the solid insulations inside the drying oven has reached an equilibrium moisture content in function of a desorption of moisture from the solid insulations.

5. The system of claim 3, further wherein the control unit is in communication with a control module of a vacuum pump that applies vacuum pressure inside the tank, and the electronic processor is enabled to instruct the vacuum pump control module to stop the application of vacuum pressure when the electronic processor has determined the moment when the moisture content of the solid insulations inside the tank has reached an equilibrium moisture content in function of a desorption of moisture from the solid insulations.

6. The system of claim 3, further wherein comprising a measurement hub in communication with the control unit, the first temperature sensor, the first pressure sensor, the second temperature sensor, the relative humidity sensor, the third temperature sensor, and the second pressure sensor.
